(19) United States
(12) Patent Application Publication
(10) Pub. No.: US 2025/0154033 A1
(43) Pub. Date: May 15, 2025

(54) METHOD FOR TREATING WASTE WATERS AND RESIDUE SLUDGE BY MEANS OF CARBONATION IN A CHEMICAL INSTALLATION FOR NITRIDATION IN A MOLTEN SALT BATH

(71) Applicant: Hydromecanique Et Frottement, Andrezieux-Boutheon (FR)

(72) Inventors: Frédéric Garcia, SAINT LAURENT D'AGNY (FR); Christophe Heau, SAINT-JEAN-BONNEFONDS (FR)

(21) Appl. No.: 18/834,054

(22) PCT Filed: Oct. 31, 2022
(86) PCT No.: PCT/FR2022/052053

§ 371 Date: Jul. 29, 2024

(30) Foreign Application Priority Data
Jan. 31, 2022 (FR) 2200855

(51) Int. Cl. C02F 1/52; C02F 101/10; C02F 103/16; C23C 8/50

(52) U.S. Cl. CPC C02F 1/5236; C02F 2101/10; C02F 2103/16; C23C 8/50

(57) ABSTRACT

The present invention relates to a method for treating waste waters (E), and/or residue sludge (B) from an oxidation bath, to recover oxidation salts, in an installation (10) for nitridation in a molten salt bath, comprising a nitridation bath (11), an oxidation bath (12), and a stop bath (13). The method comprises a transformation of hydroxide ions OH⁻ of waste waters (E) and/or residue sludge (B) into carbonate ions CO₃²⁻, and a separation of water and carbonate salts, to recover carbonate salts.

### TECHNICAL FIELD OF THE INVENTION

The present invention relates to a method for treating waste waters, and residue sludge from the oxidation bath, to recover carbonate salts and water, in a chemical installation for nitridation in a molten salt bath.

### PRIOR ART

In automotive, aeronautical, or industrial applications, the mechanical parts are generally subjected to significant stresses in operation.

Conventionally, the mechanical parts can receive treatments of a physico-chemical nature, making it possible to improve some of their properties, among which appear, in particular, friction properties, resistance to wear, resistance to fatigue, resistance to seizing, or also resistance to corrosion.

A treatment known from the prior art is nitridation. Nitridation consists of immersing a ferrous metal part in a medium which is able to transfer nitrogen, which can be, in particular, a molten salt bath. In the present text, nitridation also includes nitrocarburising, which is a variant of nitridation, in which carbon diffuses in the part in addition to nitrogen. The ARCOR® method, designed and implemented by the Applicant, is a preferred example of the nitridation method.

In reference to FIG. 1 which represents an installation for nitridation according to the prior art, such an installation 1 comprises several successive baths, among which, from upstream to downstream, a nitridation bath 2, an oxidation bath 3, and a stop bath 4, also called “water stop bath”. Upstream of the nitridation bath, a degreasing bath 5, or one or more washing baths 6, and a drying device 7 such as an oven are usually provided. Downstream of the stop bath 4, one or more washing baths 8, and a device 9 for drying parts are usually provided.

The mechanical parts are first degreased, washed, and heating by successively passing into the degreasing bath 5, into the washing baths 6, and into the drying device 7, respectively. The parts are then immersed in the nitridation bath 2, which is a molten salt bath, containing, among others, carbonates. As needed, adding regeneration salts will lead to the transformation of carbonates into cyanates, which are reactive species. Nitrogen (and optionally carbon) diffuses in the parts and precipitates in the form of nitrides, which leads to the formation of a combination layer mainly comprising iron nitrides (or other alloy elements), and an underlying diffusion zone, in which nitrogen is present between the iron atoms (solid solution) or nitrogen reacts with the alloy elements contained in steel to form nitrides.

The combined effect of the combination layer and the diffusion layer makes it possible to obtain a nitrided part having good friction properties, as well as an excellent resistance to wear and corrosion.

After nitridation, the parts are immersed in the oxidation bath 3 comprising oxidising salts, typically hydroxides and/or nitrates, to improve their resistance to corrosion and give them a uniform black appearance.

After oxidation, the parts are immersed in the stop bath 4 which contains cold water, which stops oxidation, then are cleaned by several successive washes in the washing baths 8, before being dried in the drying device 9, then discharged.

For certain treatments, the oxidation step is not required, the parts are transferred from the nitridation bath directly to a dedicated stop bath. The waters from this stop bath are nitridation salt-enriched (and no longer in oxidation salts).

Although nitridation is an effective method for improving the properties of the mechanical parts, it has the disadvantage of generating liquid and solid waste (sometimes called effluents), and requires water. This not only represents a significant ecological impact, and can cause high production costs, in particular due to the treatment of waste described below.

During an ARCOR treatment, nitridation salts are entrained by the parts and pollute the oxidation bath, then salts from the oxidation bath are entrained and transferred into the stop bath. Secondary chemical reactions also create sludge/waste even in treatment baths (nitridation and oxidation).

It is also possible that the line is used alternatively with or without oxidation and that the stop bath thus alternatively serves as a stop bath for nitridation then for oxidation. Nitridation salts and oxidation salts are thus alternatively transferred into the same stop bath.

This waste is represented in FIG. 1. These are solid effluents B, but also liquid effluents E.

The solid effluents B are called “residue sludge”. They are mainly collected in the oxidation bath 3 and in the nitridation bath 2, and are generally sent into salt mines to be treated and stored there. They contain insoluble species and salt. For the two types of salts (nitridation salt and oxidation salt), metals and metal oxides coming from the parts to be treated (iron and alloy metals) constitute insolubles. For the oxidation salt, carbonates constitute a large portion of insolubles. Residue sludge is physically removed during regular maintenance operations.

The liquid effluents E are called “waste waters”. They are collected at the outlet of the stop bath 4, and are generally sent into purification stations or managed by companies specialising in waste treatment.

In addition, the purchase costs of raw materials are themselves also relatively high, it is therefore interesting to optimise their consumption.

### BRIEF DESCRIPTION OF THE INVENTION

Faced with this situation, the Applicant has therefore sought a solution to reduce the environmental impact and to control the costs associated with nitridation methods.

The Applicant has quite specifically focused their research on reducing waste, and limiting waste for both renewable resources such as water, and non-renewable resources, such as raw materials used in nitridation and oxidation baths, i.e. nitridation and oxidation salts.

The Applicant has arrived at developing a treatment method which makes it possible to overcome all of the abovementioned disadvantages, and this, without modifying the architecture of the nitridation chains, therefore being able to be implemented on current lines.

To this end, the invention proposes a method for treating waste waters (EL), and/or residue sludge (ES) from the oxidation bath, to recover carbonate salts, in at least one chemical installation for nitridation in a molten salt bath comprising a nitridation bath, an oxidation bath, and a stop bath, the treatment method comprising the following steps:
transformation of hydroxide ions OH of waste waters (E) and/or residue sludge (B) into carbonate ions CO₃²⁻,
separation of water and carbonate salts formed by carbonate ions and metal cations from oxidation salts,
recovery of carbonate salts.

According to the treatment method of the invention, the waste waters at the outlet of the stop bath and the residue sludge from the oxidation bath are treated in order to only recover the carbonate salts. Carbonate salts, which are a component of nitridation salts, can supply the nitridation bath or be enhanced. The water recovered after the treatment process advantageously supply the stop bath and/or the washing baths with water when a water recycling step as described below is carried out.

More precisely, the residue sludge and/or the waste waters are cleared of hydroxide ions OH, the latter being components of the oxidation bath. According to the invention, the hydroxide ions are transformed into carbonate ions. The corresponding carbonate salts (carbonate ions in the form of salt) are then recovered, then advantageously reinjected into the nitridation bath.

Usually, regeneration salts are injected into the nitridation bath. Usually, regeneration salts are injected into the nitridation bath.

Thus, when recycled carbonate ions (CO₃)²⁻ are reinjected into the nitridation bath, they are converted into cyanate ions CNO— by regeneration salts.

Water is advantageously reinjected into the stop bath and/or the rinsing/washing baths.

In doing so, the oxidation and waste effluents supply the nitridation bath and advantageously, the different water tanks, in particular, the washing baths and/or the stop bath.

The re-enhancement of the carbonate salts, and if necessary, their recycling, drastically reduces the environmental impact of the industrial nitridation method, by reducing solid and liquid waste, while reusing the latter, in order to supply the method, due to this reducing the quantities and the costs of raw materials, which are nitridation salts.

The method of the invention therefore offers a double ecological and economic advantage.

It is specified that the parts can only undergo one nitridation, without oxidation, in which case the stop bath serves to stop the nitridation reaction. The method of the invention does not apply to a single nitridation line, without oxidation bath, as in this case, the recovery of carbonates can be done by simply filtering the waste waters.

The nitridation installation can comprise several nitridation baths and/or several oxidation baths and/or several stop baths.

The nitridation installation is used in the present text in its more general acceptance. The different baths that it comprises, can in practice, be installed in a same location or in different locations. For example, the decarbonation of hydroxide ions OH⁻ into carbonate ions CO₃²⁻ can be carried out with a first chemical installation in a first place, and the separation of the water and the carbonate salts be carried out with a second chemical installation in a second place different from the first. In addition, a same place may comprise several nitridation installations, i.e. several nitridation lines.

In the step of separating water and carbonate salts, the water corresponds to the waste waters and/or leaching waters of the sludge having been brought into contact with the sludge in order to extract hydroxide ions therefrom.

The transformation step can, in particular, be carried out in several ways:
transformation of hydroxide ions OH of only waste waters, or
transformation of hydroxide ions OH of residue sludge, with beforehand, a solubilisation of said hydroxide ions OH⁻ by leaching of residue sludge in water, or more generally, in an aqueous solution, for example, mains water or industrial water, or
transformation of the hydroxide ions OH⁻ of the residue sludge, with, beforehand, a solubilisation of said hydroxide ions OH by leaching of the residue sludge in the waste waters.

According to other aspects, the treatment method according to the invention has the following different features taken individually or according to their technically possible combinations:
the transformation step is carried out by reaction of hydroxide ions OH⁻ with carbon dioxide CO₂, to form carbonate ions CO₃²⁻ and water, according to the following reaction (3):

[Chem. 1]

2OH⁻+CO₂ [symbol] H₂O+CO₃²⁻ (1)
the method comprises, before the transformation of hydroxide ions OH⁻ into carbonate ions CO₃²⁻, a step of separating metal particles or metal oxides present in the waste waters, advantageously by filtration. This makes it possible to optimise the purity of the nitridation salt, since the metal particles are impurities;
the transformation of hydroxide ions OH⁻ is done by insufflation of carbon dioxide CO₂;
the transformation of hydroxide ions OH is done by insufflation of air. The hydroxides thus react with the CO₂ present in air. The transformation will take more time, but the method will be simple to implement and less expensive;
the step of separating water and carbonate salts is carried out by filtering and/or drying;
the method further comprises, after separating water and carbonate salts, a step of reinjecting carbonate salts into the nitridation bath;
the method further comprises, after separating water and carbonate salts, a step of recycling water to the stop bath and/or at least one washing bath;
the method comprises, before reinjecting carbonate salts into the nitridation bath, a step of readjusting contents of cations to the contents of the nitridation bath, to make them compatible with nitridation salts. This step consists, in practice, of adding alkaline carbonates (for example, lithium, sodium or potassium carbonates) to the carbonate salts obtained, to make their contents correspond to the experimental contents of the carbonate salts in the nitridation bath. It makes it possible to maintain a substantially constant ratio of different cations, or at the very least, limit their variations. This step is therefore quite specifically advantageous, when the carbonate salts are recycled, by reinjecting them into the nitridation bath, since the nitridation bath preserves substantially constant physico-chemical properties over time, which improves the reproducibility of the method;
the nitridation bath comprises cyanate ions CNO— and carbonate ions CO₃²⁻;
the nitridation bath further comprises alkaline ions, preferably lithium ions Lit, and/or potassium ions K⁺, and/or sodium ions Na⁺;
the oxidation bath comprises hydroxide ions OH⁻ and/or nitrate ions NO₃⁻, and optionally carbonate ions.

Some carbonate salts produced by the present method can have a significant enhancement potential, like for example, lithium carbonate Li₂CO₃.

An additional advantage of the present method is that it makes it possible to trap CO₂.

### DESCRIPTION OF THE FIGURES

Other advantages and features of the invention will appear upon reading the following description given as a non-limiting, illustrative example, in reference to the following accompanying figures:

FIG. 1 is a diagram which illustrates an industrial installation for nitridation in a molten salt bath according to the prior art.

FIG. 2 is a diagram which illustrates an industrial installation for nitridation in a molten salt bath according to the invention, in which only nitridation, oxidation, and stop baths are represented.

FIG. 3 is a diagram which illustrates, in detail, the reaction of transformation of hydroxide ions OH⁻ of residue sludge and/or wastewaters into carbonate ions CO₃²⁻ by insufflation of carbon dioxide CO₂.

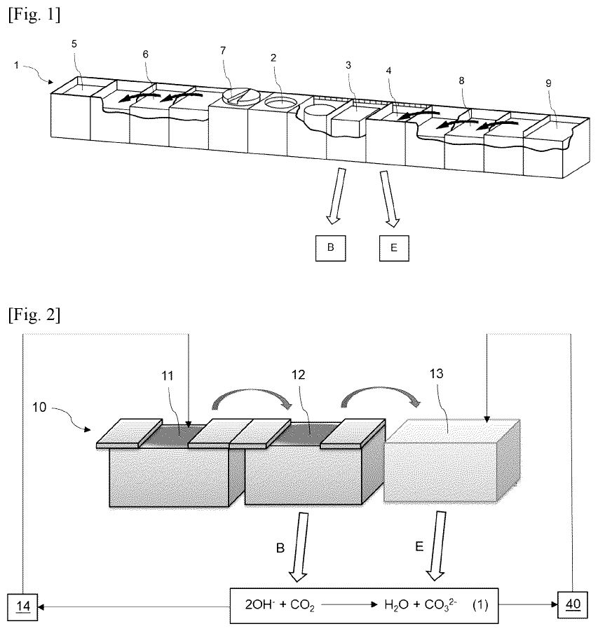

### DETAILED DESCRIPTION OF EMBODIMENTS OF THE INVENTION

The method of the invention will now be described in detail in reference to FIG. 2, which is a simplified representation of a installation 10 for nitridation in a molten salt bath, in that only the main elements of the installation are preserved, namely a nitridation bath 11, and oxidation bath 12, and a stop bath 13, with the aim of simplifying the present text.

The mechanical parts to be treated, previously degreased, then rinsed and dried in an oven, are immersed in the nitridation bath 11. The nitridation bath 11 is composed of molten nitridation salts which are brought to a temperature which is typically between 500° C. and 630° C.

Nitridation aims to give the parts a greater hardness, and to improve their mechanical properties, in particular resistance to seizing and to wear, by diffusion of nitrogen, and optionally carbon in steel, in the case of a nitrocarburising.

The nitridation bath 11 mainly comprises cyanate ions CNO and carbonate ions CO₃²⁻. Regeneration salts are added if needed in the nitridation bath to rapidly convert the carbonate ions CO₃²⁻ into cyanate ions CNO⁻.

The nitridation bath 11 further comprises alkaline ions, preferably lithium ions Lit, and/or potassium ions K⁺, and/or sodium ions Na⁺.

After the nitridation step, the mechanical parts are immersed in the oxidation bath 12. The oxidation bath 12 is composed of molten oxidising salts brought to a temperature typically of around 450° C. The oxidation salts are composed among others of hydroxides.

Oxidation aims to improve resistance to corrosion of parts, and to give them a uniform black appearance.

After the oxidation step, the parts are immersed in the stop bath 13, which contains cold water (waste water), then are cleaned in washing baths, preferably successive cascading washes, before being dried in an oven, then discharged.

As can be seen in FIG. 2, the oxidation of parts generates sludge that is extracted by degreasing the bath, leading to the formation of residue sludge B, and the stopping water generate waste waters E, which respectively constitute solid and liquid waste that the method of the invention makes it possible to recycle.

The recovery of carbonate salts is based on the transformation of hydroxide ions OH⁻ of residue sludge and/or wastewaters into carbonate ions CO₃²⁻.

Preferably, the transformation step is carried out by reaction of hydroxide ions OH⁻ with carbon dioxide CO₂, to form carbonate ions CO₃²⁻ and water, according to the following reaction (1):

[Chem. 1]

2OH−+CO₂ [symbol] H₂O+CO₂₋ (1)

The carbonate ions CO₃²⁻, referenced 14 in FIG. 2, are then reinjected in the form of salts into the nitridation bath, where they could optionally be converted into cyanate ions CNO— by regeneration salts.

It is also possible to enhance certain carbonates, in particular lithium carbonate. The latter is moreover easily separated from sodium carbonates and potassium by precipitation, thanks to its very low solubility. It can, for example, be recovered after a first decantation followed by a filtering, then the other carbonates are recovered, for example, by drying.

Preferably, before the transformation of hydroxide ions OH⁻ into carbonate ions CO₃²⁻, a step of separating metal particles or metal oxides present in the waste waters and/or the residue sludge, advantageously by filtration is carried out, optionally followed by a drying.

Preferably, after the separation of water and carbonate ions CO₃²⁻, a step of recycling water to the stop bath is carried out.

Preferably, before the reinjection of carbonate ions CO₃²⁻ into the nitridation bath, a step of separating carbonate salts and waters is carried out, advantageously by filtration, optionally followed by a drying.

Preferably, before the reinjection of carbonate ions CO₃²⁻ into the nitridation bath, a step of readjusting the contents of the cations to the contents of the nitridation bath is carried out, to make them compatible with the nitridation salts.

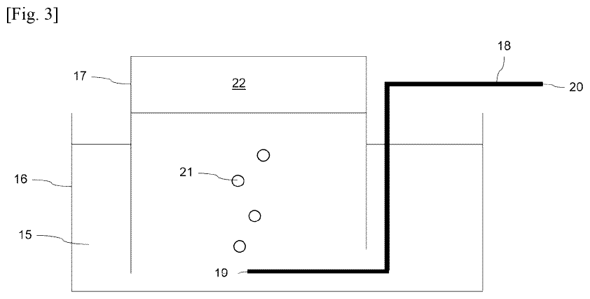

An embodiment of the transformation reaction of the hydroxide ions OH⁻ from the solubilised residue sludge and/or from the waste waters, is illustrated in more detail in FIG. 3. According to this embodiment, the reaction is carried out by carbon dioxide CO₂ insufflation.

In this figure, the waste waters E and optionally the solubilised residue sludge B are put into a solution 15 beforehand in a first glass receptacle 16. A second glass receptacle 17 is immersed in the solution 15 in the returned position, so as to make an opening for the passing of a tube 18, between the inside and the outside of the second receptacle 17. The solution 15 thus occupies the volumes of the two receptacles 16, 17. The aim of this installation is to trap carbon dioxide CO₂.

The tube 18 has a first opening 19 opening into the solution inside the second receptacle 17, and a second opening 20 opening onto the carbon dioxide CO₂ supply means outside of the receptacles 16, 17. The tube 18 is thus partially immersed in the solution 15, and passes through the two receptacles 16, 17.

The solution which is located outside of the first receptacle 16 contains hydroxide ions OH⁻ and carbonate ions CO₃²⁻.

Carbon dioxide CO₂ is injected into the second receptacle 17 via the second opening 20 of the tube 18. Carbon dioxide CO₂ bubbles 21 are formed in the solution 15 inside the second receptacle 17. The solution 15 located inside the second receptacle 17 is enriched with carbonate ions CO₃²⁻ from the reaction between carbon dioxide CO₂ and the hydroxide ions OH⁻, and the overlying region 22 is enriched with carbon dioxide CO₂, the latter being trapped by said second receptacle 17.

Subsequently, the carbonate ions CO₃²⁻ can precipitate. Precipitation depends on several parameters that can be adjusted for this purpose, in particular the concentration of the solution in hydroxide ions OH⁻, in carbonate ions CO₃², and in cations.

According to the formation of the precipitates, water 40 is thus filtered, by means of a filter press for example, then the recovered carbonates are dried. To further recover carbonates (non-precipitates), it can be considered to evaporate water by means of a drier, for example.

Solid carbonates are thus reinjected as nitridation salts in the nitridation bath. To simplify matters, the nitridation salts are, like for the carbonate ions CO₃²⁻, referenced 14 in FIG. 2.

Preferably, water 40 is recycled to the stop bath 13.

The method according to the invention thus makes it possible, not only to reduce nitridation and oxidation waste, but also to reload the nitridation bath with nitridation salts, which is conveyed by an economic and ecological recycling, in line with the current environmental standards and technicalities.

1-6. (canceled)

7. A method for treating waste waters or residue sludge from an oxidation bath to recover carbonate salts, in at least one installation for nitridation in a molten salt bath comprising a nitridation bath, an oxidation bath, and a stop bath, the treatment method comprising the following steps:
transforming hydroxide ions of waste waters or residue sludge from the oxidation bath by reaction of said hydroxide ions with carbon dioxide to form carbonate ions and water,
separating water and carbonate salts, wherein the carbonate salts are formed by carbonate ions and metal cations from oxidation salts, and recovering the carbonate salts.

8. The method according to claim 7, comprising, before transforming hydroxide ions into carbonate ions, a step of separating metal particles or metal oxides present in the waste waters or the residue sludge.

9. The method according claim 7, further comprising, after separating water and carbonate salts, a step of reinjecting carbonate salts into the nitridation bath.

10. The method according to claim 9, further comprising, before reinjecting carbonate salts into the nitridation bath, a step of readjusting contents of cations in the carbonate salts to contents of the nitridation bath, to make the carbonate salts compatible with nitridation salts.

11. The method according to claim 7, further comprising, after separating water and carbonate salts, a step of recycling water to the stop bath or at least one washing bath.
